(19) United States
(12) Patent Application Publication
(10) Pub. No.: US 2026/0111466 A1
(43) Pub. Date: Apr. 23, 2026

(54) ANALYTICS ASSISTANT USING A LARGE LANGUAGE MODEL

(71) Applicant: Roku, Inc., San Jose, CA (US)

(72) Inventors: Sakina Ibrahim Zabuawala, San Jose, CA (US); Le Zhang, San Jose, CA (US); Sunil Ramesh, Saratoga, CA (US); Erwan Suteau, San Jose, CA (US); Karina Levitian, Austin, TX (US); Andrew Fogg, Los Gatos, CA (US)

(21) Appl. No.: 18/919,019

(22) Filed: Oct. 17, 2024

(51) Int. Cl. G06F 16/33; G06F 16/22; G06F 16/332; G06F 16/338

(52) U.S. Cl. CPC G06F 16/3344; G06F 16/2282; G06F 16/3329; G06F 16/338

(57) ABSTRACT

Provided are system, apparatus, device, method and/or computer-program product embodiments, combinations and/or sub-combinations thereof for using an AI model to facilitate natural language interactions with databases. An example method can include receiving a natural language prompt associated with a user and identifying tables in a database based on the natural language prompt. The method can further include determining a table schema(s) of each of the tables identified, generating, using a large language model, a query to the tables in the database based on the natural language prompt and the table schema(s), and obtaining, using the query, data from at least one table of the tables in the database. The method can include generating, using the large language model or another large language model, a response to the natural language prompt based on the data obtained from the at least one table of the tables in the database.

### BACKGROUND

### FIELD

This disclosure is generally directed to database systems, and more particularly to an analytics assistant that implements an artificial intelligence model configured to facilitate natural language interactions with databases.

### SUMMARY

Provided herein are system, apparatus, article of manufacture, method and/or computer program product embodiments, and/or combinations and sub-combinations thereof, for using an artificial intelligence (AI) model to facilitate natural language interactions with databases.

In some aspects, a method is provided for using an AI model to facilitate natural language interactions with databases. The method can operate by receiving a natural language prompt associated with a user. In some cases, the method can further include identifying one or more tables in a database based on the natural language prompt. In some examples, the method can also include determining one or more table schemas of the one or more tables in the database. In some aspects, the method can further include generating, using a large language model, a query to the one or more tables in the database based on the natural language prompt and the one or more table schemas and obtaining, using the query, data from at least one table of the one or more tables in the database. The method can also include generating, using the large language model or another large language model, a response to the natural language prompt based on the data obtained from the at least one table of the one or more tables in the database.

In some aspects, a system is provided for using an AI model to facilitate natural language interactions with databases. The system can include one or more memories and at least one processor coupled to at least one of the one or more memories and configured to receive a natural language prompt associated with a user. The at least one processor of the system can be configured to identify one or more tables in a database based on the natural language prompt. The at least one processor of the system can also be configured to determine one or more table schemas of the one or more tables in the database. The at least one processor of the system can be configured to generate, using a large language model, a query to the one or more tables in the database based on the natural language prompt and the one or more table schemas and obtain, using the query, data from at least one table of the one or more tables in the database. The at least one processor of the system can be configured to generate, using the large language model or another large language model, a response to the natural language prompt based on the data obtained from the at least one table of the one or more tables in the database.

In some aspects, a non-transitory computer-readable medium is provided for using an AI model to facilitate natural language interactions with databases. The non-transitory computer-readable medium can have instructions stored thereon that, when executed by at least one computing device, cause the at least one computing device to receive a natural language prompt associated with a user. The instructions of the non-transitory computer-readable medium can, when executed by the at least one computing device, cause the at least one computing device to identify one or more tables in a database based on the natural language prompt. The instructions of the non-transitory computer-readable medium can, when executed by the at least one computing device, cause the at least one computing device to determine one or more table schemas of the one or more tables in the database. The instructions of the non-transitory computer-readable medium can, when executed by the at least one computing device, cause the at least one computing device to generate, using a large language model, a query to the one or more tables in the database based on the natural language prompt and the one or more table schemas and obtain, using the query, data from at least one table of the one or more tables in the database. The instructions of the non-transitory computer-readable medium can, when executed by the at least one computing device, cause the at least one computing device to generate, using the large language model or another large language model, a response to the natural language prompt based on the data obtained from the at least one table of the one or more tables in the database.

### BRIEF DESCRIPTION OF THE FIGURES

The accompanying drawings are incorporated herein and form a part of the specification.

FIG. 1 illustrates an example system that includes a large language model configured to answer user questions in a natural language, according to some examples of the present disclosure.

FIG. 2 illustrates an example system process for generating, using a system that includes a large language model, answers to user questions in a natural language based on a table schema(s), according to some examples of the present disclosure.

FIG. 3 illustrates a flowchart of an example method for using an AI model to facilitate natural language interactions with databases, according to some examples of the present disclosure.

FIG. 4 illustrates a flowchart of an example method for identifying a table in a database based on historical data, according to some examples of the present disclosure.

FIG. 5 illustrates a flowchart of an example method for using an AI model to facilitate natural language interactions with databases, according to some examples of the present disclosure.

FIG. 6A is a diagram illustrating an example of a neural network architecture, according to some examples of the present disclosure.

FIG. 6B is a diagram illustrating another example architecture that can be used to implement a large language model, according to some examples of the present disclosure.

FIG. 7 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

A database is a system used to store and organize data with defined relationships, which allows fast and/or simple retrieval of information. There are various types of database systems that can be used to store and organize data, such as object databases (or object-oriented databases), object-relational databases, relational databases, and not only SQL (NoSQL) databases (e.g., also known as non-SQL or non-relational databases), among others. Object-oriented databases are databases that represent data in the form of objects and classes. Relational databases are databases that are based on a relational model, which organizes data into tables, rows, and columns. Object-relational databases are a hybrid of object-oriented databases and relational databases. For example, object-relational databases can include relational databases that implement an object-oriented database model. On the other hand, NoSQL databases are non-relational databases such as, for example, document-oriented databases, key-value pair databases, graph databases, etc. Some databases, such as relational databases, object-oriented databases, or object-relational databases may implement a database schema that defines the structure of a corresponding database, including how data is organized within the database, and thus can explain how such database is constructed. For example, the database schema of a relational database can define the tables in the database, the relationships between tables, fields in tables, and indexes. In some cases, each table in a relational database can also include a table schema that defines the structure of the table including the columns in the table, the relationships between columns in the table, the table's primary key (e.g., the table column(s) defined as the table's primary key), and/or the data types of data in the table.

In an illustrative example, a relational database can include tables used to store specific data or types of data. Tables in the relational database can also have relationships to other tables and/or each other. For example, the relational database can have relationships between tables in the relational database, which can link the related tables. In some examples, the relationships between tables can defined or established through keys in the tables such as primary and foreign keys, which enable the database to link data across tables and ensure that the information is easily retrievable. Understanding the relationships between the tables and how data is organized across the tables can help provide a deeper understanding of the database, the tables in the database, the data in the tables, and the organization of the data in the tables. For example, data relevant to a query might be spread across multiple tables. Thus, knowledge of the table relationships or how the tables are linked can help a user or device determine where and how certain information is stored and retrieve such information.

In another illustrative example, an object-oriented database (OOD) can include classes, objects, attributes, methods, and inheritance. The data in an OOD is represented using objects (also referred to as “instances”). The objects in an OOD encapsulate data and behavior (e.g., code) into single units (e.g., the objects). Moreover, the objects can include respective states, behaviors, and attributes. The attributes of an object can describe the properties of the object, and the properties of the object can represent the state of the object. The methods of the objects in the OOD represent the behaviors of the objects, which can modify or operate on the properties of the objects. The classes include or represent groupings or collections of objects that have the same or similar structure (e.g., properties and behaviors), and each object in a class can represent an instance of the class. For example, a class can include a grouping or collection of objects that have a shared structure, such as shared attributes and behaviors (e.g., methods), and each object in the grouping or collection of objects can represent an instance of the class associated with the grouping or collection of objects. The classes and objects in an OOD can be related to each other using inheritance and association relationships. Inheritance enables an object to acquire attributes (e.g., properties) and methods of another object (e.g., by reusing existing fields and methods of the other object). The objects in an OOD can have many-to-many relationships and can be accessed using pointers (e.g., addresses), which link objects to establish object relationships.

Generally, it can be very difficult to navigate databases in order to find and/or access relevant data and/or entities in the database, particularly with larger databases containing a larger amount of data and entities, such as tables in a relational database or classes (and/or objects) in an OOD. For example, navigating a large number of database entities (e.g., tables in a relational database or classes in an OOD) in a database to find a relevant entity in the database that contains desired information can be laborious and time-consuming. As the size of the database increases, it can become increasingly more difficult to understand the structure of the database and find specific entities and data of interest in the database.

Provided herein are system, apparatus, device, method (also referred to as a process) and/or computer program product embodiments, combinations and/or sub-combinations thereof (also referred to as “systems and techniques” hereinafter) for using an artificial intelligence (AI) model to facilitate natural language interactions with databases. The AI model can allow users to more easily and efficiently navigate a database using natural language, obtain relevant information from and/or about the database, and understand the database and associated data. In some examples, the systems and techniques described herein can use a large language model (LLM) and schema information about database entities (e.g., data structures such as tables, objects, classes of objects, etc.) to obtain or provide relevant information from a database, obtain or provide relevant information about the database and/or about data in the database, obtain or provide information generated based on data from the database, and/or reduce (or eliminate) the burden and time otherwise involved in navigating databases, particularly databases with a larger amount of data and entities (e.g., tables, classes, objects, etc.). For example, in use cases involving a relational database, the LLM can use a table schema(s) of one or more database tables and information obtained by querying the one or more tables to generate answers to analytical questions in a natural language. As another example, in use cases involving an object database or an object-relational database, the LLM can use a schema(s) of one or more database entities (e.g., classes and/or objects) and information obtained by querying the one or more database entities to generate answers to analytical questions in a natural language.

In some examples, the systems and techniques described herein can use an LLM to translate, based on one or more entity schemas such as table schemas, a natural language prompt into a query in a programming language, which can be used to fetch data from a database. For example, an LLM can use one or more table schemas to translate an analytical question in a natural language into a precise and efficient query in a programming language. The LLM (or any other system/device) can use such query to accurately and/or efficiently retrieve data in a database, which the LLM can use to generate a response to the analytical question. In some aspects, the systems and techniques described herein can use the LLM to generate a summary of the response to the natural language prompt and/or a visualization of information pertinent to the response, such as statistics (e.g., a chart, a bar graph, a histogram, a plot, a map, etc.) pertinent to the response.

As previously noted, the systems and techniques described herein can receive a natural language prompt, such as an analytical question from a user or device, and generate a response to the natural language prompt using information from a database. For example, a user, such as a product manager of a company, may provide an input to an LLM containing a natural language prompt. In some examples, the natural language prompt can include a question for the LLM to process, such as a question asking about a number of device activations per product line, a product's sales performance over a particular year, and/or anything else. The natural language prompt can be in one or more forms of a natural language such as text and/or audio. The LLM can then generate a response to the natural language prompt from the user. To generate the response to the natural language prompt, the LLM can access a database that stores relevant data, such as a relational database storing a collection of data organized in tables or an OOD storing data represented in the form of objects associated with one or more OOD classes. The LLM can identify one or more database entities, such as tables in a relational database or classes/objects in an OOD, that may be relevant to the natural language prompt, and retrieve information from the one or more database entities used to generate the response to the natural language prompt. In some examples, the LLM can identify the relevant database entities (e.g., tables, classes, objects, etc.) based on information (e.g., one or more words) in the natural language prompt, a syntax of the natural language prompt, a respective confidence metric of each of the one or more database entities, historical data (e.g., similar user prompts and tables that were used previously), correlating data in a database that can be obtained from cross-correlation analysis, and/or any other information as further described herein.

In some examples, the LLM can generate descriptions associated with the database entities (e.g., the tables, classes, or objects), which can be used to identify specific database entities (e.g., tables, classes, objects, etc.) that may be relevant to generating a response to the natural language prompt. For example, the LLM can generate metadata/data associated with one or more entities (e.g., one or more tables, classes, objects, column names, table description, etc.) in the database. In some examples, the generated metadata/data can include information about the one or more entities in the database, such as descriptions of the one or more entities (e.g., tables, classes, objects, etc.) in the database. As follows, once the LLM has generated the metadata/data for the one or more entities in the database, the LLM can use the natural language prompt and the metadata/data associated with the one or more entities to identify which entity/entities (e.g., which table(s), object(s), class(es), etc.) is/are relevant to the natural language prompt. In some examples, the generated metadata/data can be included as part of table schemas and can be used to obtain data from relevant tables in a database.

The systems and techniques described herein can determine schemas of the relevant database entities, such as tables, classes, or objects. For example, the systems and techniques described herein can determine the table schemas of relevant tables in a database. The table schema of a table in a database can define the structure of the table in the database. In some examples, the table schema can include information about the columns in the table, the fields in the table, the data type(s) associated with the table, objects in the table, descriptions associated with the table, constraints defined for the table (e.g., rules that apply to the data in the table), indexes associated with the table, any relationships of the table (and/or data within the table) to one or more other tables (and/or data within the one or more other tables), and/or other information about the table. Based on the table schemas and the natural language prompt, the systems and techniques described herein can then generate a query in a programming language, which can be used to obtain data from the relevant tables in the database.

In some aspects, an LLM according to the systems and techniques described herein can generate a response or a summary of the response to the natural language prompt based on at least one of the table schemas of the tables in the database, data from the tables used to determine the response to the natural language prompt, and/or a description of statistics about the data from the tables used to determine the response. For example, instead of feeding the entire relevant tables to an LLM, the systems and techniques described herein can provide the table schemas of the relevant tables in the database to the LLM, which can then use the table schemas to generate a natural language response to the natural language prompt.

In some examples, the LLM can generate a query for a database, which can be generated in and/or according to a particular data/database query language, based on the natural language prompt and the table schemas of the relevant tables. For example, the LLM can translate a user question in a natural language into a query in a programming language. The LLM can use the query to obtain the data used to determine the response to the natural language prompt from the relevant tables.

In some aspects, the LLM can generate statistics and/or a description of statistics about the data from the relevant tables used to determine the response to the natural language prompt. For example, the LLM can generate a text description of statistics about the data from the relevant tables. The LLM can obtain and/or generate the statistics from or based on the results to the query generated by the LLM, which can include data obtained from the database using the query. In some examples, the LLM can use the description of the statistics to generate a visualization of statistics (e.g., a chart, a bar graph, a histogram, a plot, a map, etc.) related to the response to the natural language prompt.

As discussed in further detail below, the technologies and techniques described herein can improve the efficiency and effectiveness of generating a response to a user's prompt by utilizing scalable table schemas of relevant entities (e.g., tables, classes, objects, etc.) in a database rather than feeding entire entities to a model, and using an LLM to translate a natural language prompt into a query generated according to a particular programming language to accurately, efficiently, and effectively retrieve data from the database. Further, a visual representation of the query results can help a user better understand the response and improve the user experience. As used herein, an entity in a database can refer to a table in a database, a class of objects in a database, or an object in a database.

As follows, the systems and techniques described herein will be described with respect to relational databases and table schemas associated with the relational databases. However, the relational databases and table schemas are one illustrative example of databases and schemas that can be used by the systems and techniques described herein, which are provided for explanation purposes. One of ordinary skill in the art will recognize from the disclosure that, in other examples, the systems and techniques described herein can be implemented using other types of databases and data structure schemas, such as object databases, object-relational databases, database object schemas, schemas of other database data structure such as objects or classes of objects, etc. Moreover, while the systems and techniques described herein will be described with respect to an LLM, it should be noted that the LLM is one illustrative example of a model that can be implemented by the systems and techniques described herein. However, in other examples, other types of AI or machine learning (ML) models can be implemented instead of or in addition to an LLM(s), such as a convolutional neural network model and/or any other AI/ML model.

### Analytics Assistant System Using a Large Language Model

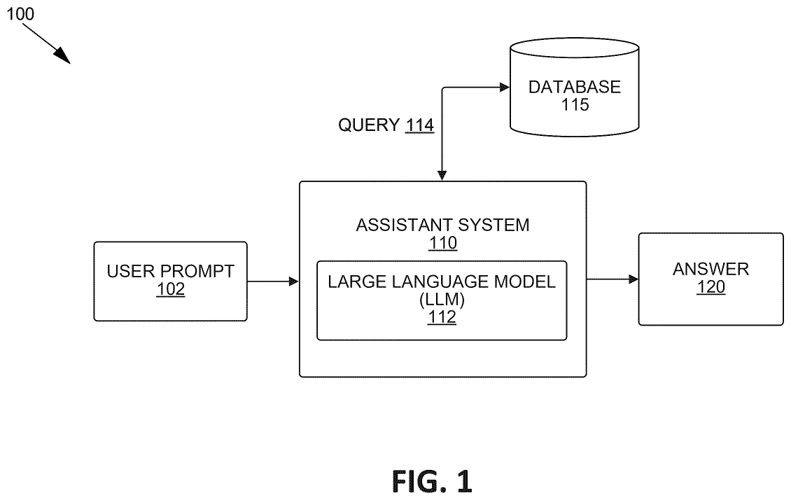

FIG. 1 is an example system 100 for using an AI model to facilitate natural language interactions with databases, according to some examples of the present disclosure. In some examples, the AI model can include an LLM and the example system 100 can use the LLM to generate answers to natural language prompts using data from a database, and enable other natural language interactions with the database. As shown, the assistant system 110 can include large language model (LLM) 112, which represents one or more LLMs. The assistant system 110 can use LLM 112 to generate an answer 120 to user prompt 102 based at least partially on data from database 115. In some examples, user prompt 102 can include a natural language prompt, such as a question in a natural language form (e.g., text and/or audio/voice).

For example, the user prompt 102 can include natural language text provided by the user as an input to the LLM 112 of the assistant system 110 (e.g., text entered by the user via a text box and/or any other input field), a voice input provided by the user as a natural language input to the LLM 112 of the assistant system 110 (e.g., a voice input including speech from the user recorded via a microphone), a transcript of speech provided by the user and recognized by a speech recognition system using automatic speech recognition (ASR) (which can be implemented by assistant system 110 or a separate system not shown in FIG. 1), etc. In some cases, the user prompt 102 can additionally or alternatively include or be based on other types of user inputs such as, for example and without limitation, touch gestures provided by the user via a touchscreen device used by the user to select one or more options or provide one or more other touch inputs (e.g., type on a virtual keyboard, etc.), gestures provided by the user as an input to the assistant system 110 and recognized by a gesture recognition system (e.g., implemented by the assistant system 110 or a separate system not shown in FIG. 1) from camera data depicting the gestures from the user, and/or any other user input and type of user input.

Assistant system 110 may access database 115 to determine a response to user prompt 102. The database 115 may store data organized in or using a particular structure, database scheme, and/or database entity, such as a table, a class of database objects, a database object, or any other type of data structure. In some examples, database 115 can represent a database that includes tables used to store data. In such examples, each table can include a table name identifying the table uniquely within the database, columns of data, rows of data, indexes, constraints (e.g., rules on the data in the table), relationships with one or more other tables (e.g., through a primary key and/or a foreign key), metadata, etc. In other examples, database 115 can include objects used to store data, classes of objects, object attributes/properties, code used to implement (and/or encapsulating) object behaviors or methods, pointers used to facilitate object access and establish relationships between objects, inheritances, variables, messages, etc. The assistant system 110 (e.g., the LLM 112) can access database 115 and analyze entities (e.g., tables, etc.) in the database 115 to identify one or more entities (e.g., tables) that are relevant to user prompt 102, which in some cases may be used by the LLM 112 to obtain data used to generate answer 120. In some cases, the assistant system 110 (e.g., the LLM 112) can determine that one or more entities are relevant to user prompt 102 based on one or more parameters such as, for example and without limitation, one or more words and/or utterances in user prompt 102, one or more syntaxes of user prompt 102, confidence metrics of entities in the database 115, descriptions of entities in the database 115, and so on.

The assistant system 110 can determine entity schemas of the relevant entities in database 115, such as table schemas of relevant tables in database 115 or schemas of relevant classes and/or objects in database 115. As previously noted, a table schema defines the structure of a table in a database and can include information about the table such as, for example, table columns, fields, data types, objects, descriptions, constraints (e.g., rules that apply to the data in the table), indexes, relationships to other tables, keys (e.g., primary key, foreign key, etc.), and/or any other table information. In some examples, the table schemas of relevant tables identified by the assistant system 110 and user prompt 102 can be fed as input into LLM 112 to generate answer 120. The LLM 112 can use the table schemas and user prompt 102 to generate query 114 in a programming language suitable for querying database 115. As previously described, rather than feeding entire relevant tables into LLM 112, assistant system 110 feeds the table schemas of relevant tables along with user prompt 102 into LLM 112, which can generate query 114 based on the table schemas and user prompt 102. For example, LLM 112 can translate user prompt 102 and use the translation of user prompt 102 and the table schemas to generate the query 114 in a particular programming language. LLM 112 can use query 114 to obtain data from database 115 used by LLM 112 to generate answer 120.

In other examples, the assistant system 110 can determine the schema of another type of database entity that is relevant to the user prompt 102, such as a database class, object, or any other database data structure or construct. Here, the assistant system 110 can provide to the LLM 112 the user prompt 102 and the schema of the other type of database entity that is relevant to the user prompt 102. The LLM 112 can use the schema and user prompt 102 to generate answer 120 in a programming language suitable for querying database 115, as previously described. In this example, rather than feeding the entire database entity associated with the schema into LLM 112, assistant system 110 can feed the schema into LLM 112. The LLM 112 can then use the schema and the user prompt 102 to generate query 114. For example, LLM 112 can translate user prompt 102 and use the translation of user prompt 102 and the schema of the relevant database entity to generate the query 114 in a particular programming language. LLM 112 can use query 114 to obtain data from database 115 that LLM 112 can use to generate answer 120, as previously described.

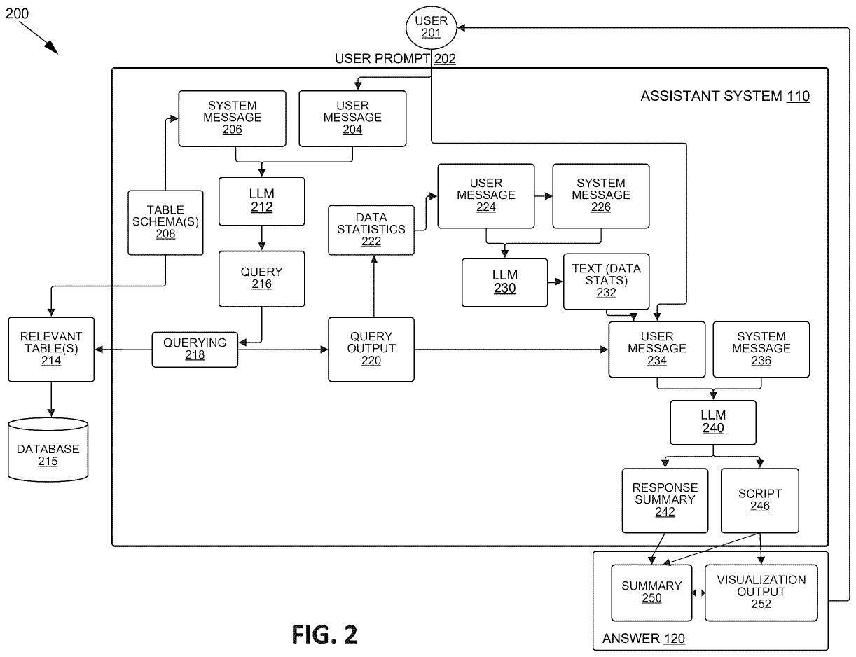

FIG. 2 illustrates an example system process 200 for using an AI model to facilitate natural language interactions with databases, according to some examples of the present disclosure. For example, the example system process 200 can be used by one or more LLMs of the assistant system 110 to generate an answer to a question in a natural language based on a schema(s) of one or more entities in a database, such as one or more tables, classes, objects, etc. For explanation purposes, the example system process 200 in FIG. 2 is described with respect to table schemas of tables in database 215, which in such examples can represent a relational database or any other database that contains tables. However, in other examples, the example system process 200 can use a schema(s) of any other type of database entity in any other type of database, such as a schema(s) of one or more objects or classes of objects in an object-oriented database or an object-relational database, or a schema(s) of any database data structure other than tables, classes, or objects contained in any type of database. For example, in some cases, the example system process 200 can generate an answer to a question in a natural language based on a schema(s) of one or more classes of objects in an object database or one or more objects in the object database.

As described previously, assistant system 110 can include one or more LLMs configured to generate an answer 120 in response to a natural language prompt. The assistant system 110 can receive user prompt 202 from user 201 and use one or more LLMs (e.g., LLM 212, LLM 230, and LLM 240) to generate answer 120. In some examples, user prompt 202 can include or represent a natural language prompt. Moreover, user prompt 202 can be the same as or similar to user prompt 102 illustrated in FIG. 1. In some examples, answer 120 can include a summary of a response to user prompt 202 determined by the one or more LLMs, statistics related to the response to user prompt 202, a visualization of statistics (e.g., a chart, a bar graph, a histogram, a plot, a map, etc.) related to the response to user prompt 202, and/or other relevant data. For example, answer 120 can include summary 250, which can include a summary of information in a natural language, and visualization output 252.

In some examples, user prompt 202 can include a question, such as an analytical question, about underlying patterns, relationships, causes, details, features, statistics, and/or effects that can be observed in data from database 215 and/or data generated based on data from database 215. In some examples, user prompt 202 can include a question or analytical question about information, details, features, and/or aspects observed in data from database 215 regarding, for example, product developments, performance, market analysis, solutions, errors, services, products, operations, entities, customers, transactions, business partners, tasks, sales, purchases, assets, etc. For example, a product manager (e.g., user 201) can type a question in an input element (e.g., a help center text box, a text field in a user interface, a text field in an application, etc.) asking about product sales performance, device activations, user engagement and retention, and so on. The user prompt 202 can include the question from the product manager and/or a representation thereof. The assistant system then provides user prompt 202 to LLM 212 as user message 204.

In some examples, assistant system 110 can determine an amount of computation resources and/or computation time for the assistant system 110 to process user prompt 202. Assistant system 110 can then determine whether the amount of computation resources and/or computation time exceeds a threshold, and determine whether to modify user prompt 202 and/or include data from the modified user prompt 202 in the user message 204 for the LLM 212. For example, in response to determining that the amount of computation resources and/or computation time exceeds a threshold, assistant system 110 can modify user prompt 202 to reduce the amount of computation resources and/or computation time and include data from the modified user prompt 202 in the user message 204 provided to LLM 212. In some examples, modifying the natural language prompt can include, for example without limitation, removing one or more terms from the prompt, summarizing the prompt, or replacing the prompt with a shorter prompt that describes or includes a semantic meaning of the prompt.

The assistant system 110 may access database 215 to identify relevant tables 214 (e.g., tables in database 215 that are relevant to user prompt 202). In some examples, each table in database 215 can include a table name identifying the table uniquely within the database (e.g., products, orders, activations, sales, etc.), columns, rows, indexes, constraints (e.g., rules on the data in the table), relationships, metadata, etc. The relevance of the tables to the user prompt 202 can be based on one or more parameters such as, for example and without limitation, words and/or an utterance in the user prompt 202, a syntax of the user prompt 202, confidence metrics of tables, historical data, written descriptions or any other components of the table, etc. In some examples, assistant system 110 can use words and/or syntaxes included or conveyed in the user prompt 202 to determine which tables in database 115 are relevant to the user prompt 202. For example, if the user prompt 202 includes a particular product name, the assistant system 110 can identify a table(s) with a table name that has the same product name or a table with a name that indicates that the table contains product names and/or the particular product name.

In some aspects, assistant system 110 can evaluate a confidence metric of each table to identify tables that may be relevant to user prompt 202. A confidence metric can be represented as a percentage or probability value, a value within a range, a weight or bias, or any other value(s). In some examples, a confidence metric of a table can be determined based on similarity between terms or keywords in user prompt 202 and terms or keywords in a table. The assistant system 110 can compare user prompt 202 to data in the table to determine any matches, similarities, etc. The matching/comparing can be literal (e.g., comparing exact terms) and/or semantic (e.g., different terms can be a match if they have the same or similar semantic meaning). Further, a confidence metric of a table can be determined based on, for example and without limitation, usage of the table in other applications (e.g., being used to generate an answer for other prompts), the latest update of the table, and so on. For example, a table that has not been accessed for a year may have a lower confidence metric than a table that has been frequently accessed in the past year. In another example, a table that was updated a day ago may have a higher confidence metric than an outdated table that has not been updated in the past year.

In some examples, assistant system 110 can access historical data (not shown). The historical data can include previous natural language prompts and/or associated relevance results. The assistant system 110 can identify one or more previous natural language prompts that match or have a threshold similarity to user prompt 202. For example, assistant system 110 can determine a similarity of the previous prompts to user prompt 202 based on content of the prompts such as words or syntaxes of the prompts, roles of users, etc. If the similarity between a previous prompt and user prompt 202 exceeds a similarity threshold, assistant system 110 may identify the tables that were used in that previous prompt as relevant tables 214. For example, if the same words or syntaxes were used in the previous prompt and user prompt 202, assistant system 110 can review tables that were used to generate an answer for the previous prompt and identify them as relevant tables 214.

In some cases, assistant system 110 can use an LLM (e.g., LLM 212 or any applicable LLM) to generate descriptions associated with tables in database 215. The descriptions can be used to identify specific tables that may be relevant to generating a response to user prompt 202. For example, an LLM can be used to generate table metadata/data with descriptions of the tables in the database 215. As follows, once the LLM has generated the metadata/data for the tables in the database 215, assistant system 110 can use user prompt 202 and the table metadata/data with the table descriptions to identify which table(s) in the database 215 is/are relevant to the prompt (e.g., relevant tables 214).

From the relevant tables 214, assistant system 110 can obtain table schemas 208 of the relevant tables 214 in database 215. The table schemas 208 can include information about the table(s) such as, for example, columns, fields, data types, objects, descriptions, keys (e.g., primary keys, foreign keys, etc.), constraints (e.g., rules that apply to the data in the table), indexes, and any relationships to other tables. Based on table schemas 208 of relevant tables 214, assistant system 110 may create system message 206 and provide system message 206 to LLM 212. In some examples, system message 206 can include a natural language description of table schemas 208, which can be processed by LLM 212. In some aspects, system message 206 can include a role of LLM 212 that can be taken when analyzing table schemas 208 and user prompt 202 and generating an output (e.g., query 216). In some aspects, system message 206 can include a flavor(s) of a programming language to be used in query 216, for example, defining unique commands, data types, scalability, or functions that can be specified for the programming language in query 216.

The assistant system 110 can feed user message 204 and system message 206 into LLM 212. LLM 212 can be configured to use user message 204 and system message 206 to generate query 216 in a programming language. In some examples, the LLM 212 can translate user prompt 202 included or encoded in user message 204 and use the translation to generate query 216 in a programming language.

In some aspects, assistant system 110 can perform querying 218 to obtain data from database 215. For example, assistant system 110 can use query 216 to generate query output 220 (e.g., data obtained using query 216) from relevant tables 214 and any other tables in database 215. In some examples, assistant system 110 can access relevant tables 214 to generate query output 220. Upon receipt of user feedback regarding relevant tables 214 or query output 220 (e.g., indicating that an incorrect table has been used, etc.) or user request to access other tables, assistant system 110 can access other tables in database 215 and generate query output 220.

In some examples, assistant system 110 can generate, based on query output 220, data statistics 222 about the data from relevant tables 214 (e.g., statistics about the raw data and/or the response). Non-limiting examples of statistics that can be included in data statistics 222 include a minimum, a maximum, mean, average, etc. In some examples, if user prompt 202 is related to a value, data statistics 222 can include statistics in terms of ranges.

The assistant system 110 can create user message 224 that describes and/or encodes data statistics 222 and system message 226 that defines a role of LLM 230, a desired type or format of output of LLM 230, and so on. The LLM 230 can then generate text 232, which includes a text description of data statistics 222. In some examples, text 232 can also optionally include a text description of the data (or a portion thereof) from relevant tables 214 (e.g., query output 220).

In some aspects, assistant system 110 can create user message 234 based on text 232, query output 220 (e.g., data obtained from relevant tables 214 by using query 216), and/or user prompt 202. Assistant system 110 can then feed user message 234 into LLM 240 as one of the inputs to LLM 240. Assistant system 110 can also create system message 236, which defines a role of LLM 240, a desired type or format of output of LLM 240, a number of fields to be created (e.g., one for a textual output and another for a script output), and so on. In some examples, the number of fields to be created can include a field for a textual output and another field for a script output.

In some examples, assistant system 110 can feed user message 234 and system message 236 into LLM 240, which is configured to generate response summary 242 and/or script 246. Based on the output of LLM 240 (e.g., response summary 242 and/or script 246), assistant system 110 can generate answer 120, which includes summary 250 and/or visualization output 252. For example, assistant system 110 can generate summary 250 that summarizes a response to user prompt 202 based on response summary 242 and/or script 246. Also, assistant system 110 can generate visualization output 252 (e.g., a visualization of statistics related to a response) based on script 246. The visualization output 252 can be represented as a chart, a bar graph, a histogram, a plot, a map, and/or any other visual output.

In some examples, answer 120 can be transmitted to a user device (not shown) associated with user 201 for user feedback. The user 201 can optionally enter (e.g., via the user device), based on answer 120, an additional prompt including such user feedback. In some cases, the additional prompt from user 201 can include a follow-up question relating to summary 250, revisions to summary 250 (e.g., adding additional details or removing a particular portion of summary 250), changes to a format of visualization output 252, etc.

In some aspects, assistant system 110 can receive user feedback with respect to relevant tables 214. For example, assistant system 110 can provide what tables are identified as relevant in database 215 to user 201 for user feedback prior to feeding system message 206 into LLM 212. In some examples, assistant system 110 can identify relevant tables 214 based on user prompt 202 and use user feedback to either confirm that the tables identified is correct tables or to refine table identification (e.g., to include a different table(s) and/or exclude the table(s) previously identified).

In some implementations, assistant system 110 can generate multiple summaries of responses to user prompt 202. Each summary can be generated based on a respective table schema of a respective table of the relevant tables. Further, assistant system 110 can identify or note the differences between the summaries.

In some examples, assistant system 110 can leverage a Retrieval-Augmented Generation (RAG) system to be incorporated with an LLM (e.g., LLM 212, LLM 230, and/or LLM 240) such that the LLM can create a response to user prompt 202 based not only on information it was trained on but also external data (e.g., new data outside of the LLM's training data) that can come from multiple data sources such as APIs, databases, and/or document repositories (e.g., scientific papers, product manuals, customer support logs, etc.). For example, a RAG system can be deployed to provide intermediary data to assist an LLM (e.g., LLM 212, LLM 230, and/or LLM 240) in generating a contextually informed response to user prompt 202.

In some implementations, when identifying relevant tables 214 in database 215, assistant system 110 can add or request more data from one or more sources such as user 201, a data store, the Internet, another table in database 215, and/or another database). For example, when identifying relevant tables 214 in database 215, assistant system 110 may determine that more data is needed to generate a response to user prompt 202. In some examples, assistant system 110 can identify a deficiency of data in database 215 for generating a response to user prompt 202 and note in the output that more data is needed.

While individual LLMs (e.g., LLM 212, LLM 230, LLM 240) are illustrated for explanation purposes in FIG. 2, a single or any applicable number of LLMs can be used without departing the scope of the present disclosure. For example, in some cases, LLM 212, LLM 230, LLM 240 can represent separate LLMs. In other cases, LLM 212, LLM 230, LLM 240 can represent or be part of a same LLM. In yet other cases, two of the LLMs from LLM 212, LLM 230, LLM 240 can represent or be part of a same LLM, and the other LLM from LLM 212, LLM 230, LLM 240 can include or represent a separate LLM.

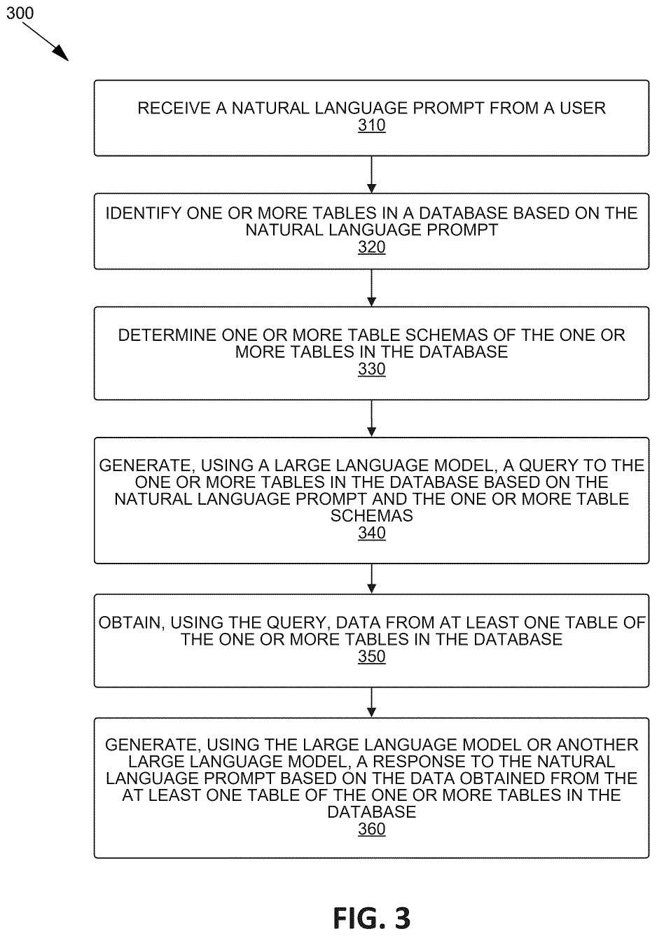

FIG. 3 is a diagram illustrating a flowchart of an example method 300 for using an AI model to facilitate natural language interactions with databases. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIGS. 1 and 2. However, method 300 is not limited to those examples.

In step 310, assistant system 110 can receive a natural language prompt from a user (or from a device associated with the user). For example, assistant system 110 can receive user prompt 202 in a natural language from user 201 or a device associated with user 201, such as a laptop computer, a desktop computer, a smartphone, a video game console, a mobile device, a smart wearable device, or any other computing device. The user prompt 202 can include a voice input from the user such as, for example and without limitation, an analytical question about patterns or relationships within data, database entities, and/or objects related to items included, described, and/or represented in a database such as products, services, markets, users, sales, transactions, etc. To illustrate, in one example, the natural language prompt can be typed by a product manager in an input element (e.g., a help center text box, an input field, etc.) about activations of smart TVs per product line and screen size.

In step 320, assistant system 110 can identify one or more tables in a database based on the natural language prompt. For example, assistant system 110 can identify relevant tables 214 in database 215 based on user prompt 202. As previously illustrated, assistant system 110 can determine the relevancy of tables in database 215 to user prompt 202 based on one or more parameters such as, for example, content (e.g., words/utterances, syntaxes, etc.) of user prompt 202, confidence metrics of tables, descriptions of tables, similarities or dissimilarities between the user prompt 202 and information associated with the tables (e.g., table names, table identifiers, table metadata, data and/or objects in the tables, tags associated with the tables, type of content in the tables and/or content categories associated with the tables, etc.), and so on. For example, in the illustrative example of a product manager's question about smart TV activations, assistant system 110 can identify tables in database 215 that have columns for device activations for each product line and for each screen size.

In step 330, assistant system 110 can determine one or more table schemas of the one or more tables in the database. For example, assistant system 110 can determine table schemas 208 of relevant tables 214. As previously illustrated, a table schema of a table defines the structure of the table and includes information associated with the table such as, for example and without limitation, a table name, a table description, a relationship to one or more other tables, table columns, indexes, keys (e.g., primary key, foreign key, secondary key, etc.), table metadata, data types of data in the table, table rules or constraints, etc.

In step 340, assistant system 110 can generate, using a large language model, a query to tables in a database. For example, assistant system 110 can use an LLM (e.g., LLM 112, LLM 212) to generate, based on table schemas 208 and user prompt 202, a query 216 in a programming language. The assistant system 110 can feed user message 204 and system message 206 into LLM 212. The LLM 212 can be configured to use user message 204 and system message 206 to generate query 216 in a programming language. In some examples, LLM 212 can translate user prompt 202 included or encoded in user message 204 and use the translation to generate query 216 in a programming language.

In step 350, assistant system 110 can obtain, using query 216, data from relevant tables 214 or any other tables in database 215. The assistant system 110 can generate query results, such as query output 220, which includes the data obtained from relevant tables 214 or any other tables in database 215. Further, assistant system 110 can use query output 220 to generate data statistics 222. The LLM 230 may generate, based on query output 220, a textual description of data statistics (e.g., text 232). The statistics pertinent to the data from relevant tables 214 can include a minimum, a maximum, mean, average, total, frequency, etc. For example, in the illustrative example of a product manager's question about smart TV activations, data statistics 222 can include a minimum or maximum number of activations between different product lines or between different screen sizes in the same product line.

In step 360, assistant system 110 can generate, using a large language model or another large language model, a response to the natural language prompt based on the data obtained from the at least one table of the one or more tables in the database 215. For example, LLM 112 (e.g., LLM 212, LLM 230, LLM 240, or a combination thereof) of assistant system 110 can generate summary 250 of a response to user prompt 202 based on query output 220 (which includes the data obtained from tables in database 215), text 232 (e.g., a textual description of data statistics), and/or user prompt 202.

In some examples, assistant system 110 can generate a visualization of the response summary or statistics pertinent to the data used to determine the response (e.g., a summary of trends that are observed in the data). For example, assistant system 110 can generate visualization output 252. Visualization output 252 can include, for example and without limitation, a chart, a bar graph, a histogram, a plot, a map, and/or any other visual output to help users understand the response and/or statistics. For example, assistant system 110 can generate a bar chart that shows the relationship between device activations per screen size where color-coded bars can be represented for each product line.

In some instances, assistant system 110 can receive user feedback. For example, assistant system 110 can receive feedback from user 201 with respect to relevant tables 214 or answer 120. In some cases, assistant system 110 can receive a second prompt (e.g., a follow-up question) from user 201 that provides feedback about relevant tables 214, answer 120, etc. In another example, assistant system 110 can receive feedback from user 201 regarding relevant tables 214 such as a request to look for different tables, remove a particular table, try a different database, and so on. In some examples, assistant system 110 can receive feedback from other users such as team members, supervisors, database administrators, or any other person who may be familiar with the database or tables. In some aspects, assistant system 110 can use the user feedback to identify tables again based on the user feedback or refine the tables identified based on the user feedback.

The example method 300 is described with reference to tables and table schemas. However, in other examples, the method 300 can be implemented using other types of database entities, schemas, and/or databases that do not include tables. For example, in some cases, instead of identifying one or more tables, the method 300 at step 320 can identify one or more classes of objects in an object database, and instead of determining one or more table schemas at step 330, the method 300 can determine one or more schemas of the one or more classes of objects. As another example, instead of identifying one or more tables, the method 300 at step 320 can identify one or more objects in an object database, and instead of determining one or more table schemas at step 330, the method 300 can determine one or more schemas of the one or more objects. As yet another example, instead of identifying one or more tables, the method 300 at step 320 can identify one or more data structures (e.g., instead of or in addition to tables, objects, and/or classes of objects) in a database, and instead of determining one or more table schemas at step 330, the method 300 can determine one or more schemas of the one or more data structures.

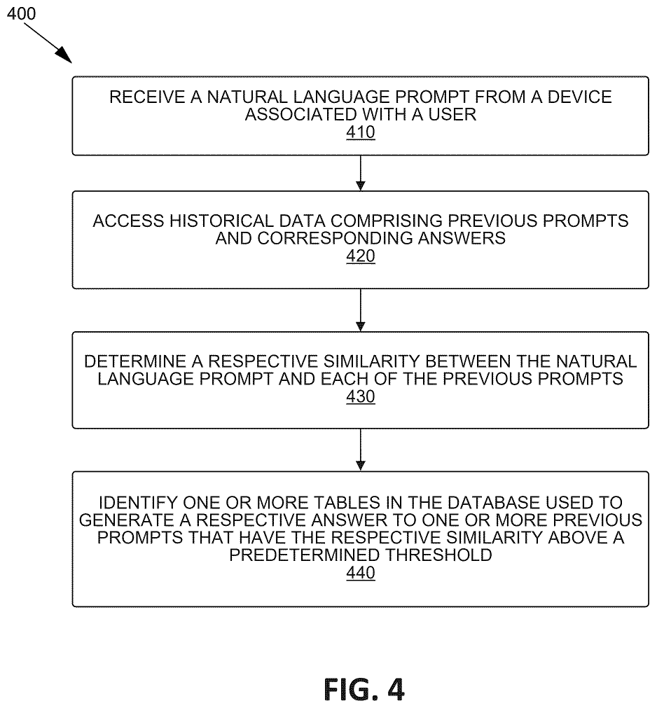

FIG. 4 is a diagram illustrating a flowchart of an example method 400 for identifying a table in a database based on historical data. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1 and 2. However, method 400 is not limited to those examples.

In step 410, assistant system 110 can receive a natural language prompt from a user (or a device associated with a user). For example, assistant system 110 can receive user prompt 202 from user 201 (e.g., as text, audio such as voice/speech, gestures, and/or any other form).

In step 420, assistant system 110 can access historical data including previous prompts and corresponding answers, for example from a database that stores previous prompts that assistant system 110 has received, tables that were used to generate answers, and/or corresponding answers. For example, assistant system 110 can access previous natural language prompts that were received from user 201 and/or other users prior to the natural language prompt received at step 410. Further, assistant system 110 can access, from a database, corresponding answers (e.g., a response summary and/or visualization output) that were provided in response to the previous natural language prompts.

In step 430, assistant system 110 can determine a respective similarity between the natural language prompt and each of the previous prompts. In some examples, a similarity between a previous language prompt and user prompt 202 can be determined based on one or more parameters such as words and/or syntaxes of a prompt, a role of a user or a person who requested the prompt (e.g., an analyst, a product manager, a salesperson, a customer, etc.), and so on. For example, assistant system 110 can compare if the same words or synonyms were used in the previous natural language prompt and user prompt 202.

In step 440, assistant system 110 can identify one or more tables in the database used to generate a respective answer to one or more previous prompts that have the respective similarity above a predetermined threshold. In some examples, assistant system 110 can identify previous prompts that have similarities exceed a predetermined threshold. Further, assistant system 110 can identify corresponding tables that were used to generate an answer to the previous prompts, and add those tables as relevant tables 214. As follows, assistant system 110 can obtain data from the tables that were used for the previous prompts for determining a response to user prompt 202.

In some examples, assistant system 110 can provide, to a device associated with user 201, a previous natural language prompt that has a similarity to the prompt from step 410 that exceeds a predetermined threshold. In some aspects, assistant system 110 can receive user feedback from a device associated with user 201 regarding the similar previous prompt and/or modified or updated user prompt or additional user prompt. In some aspects, assistant system 110 can further provide a response generated for the previous natural language prompt, to a device associated with user 201, along with a response generated for user prompt 202 for comparison.

The assistant system 110 can leverage historical data to monitor and reorganize the database 215. In some examples, assistant system 110 can access historical data including previous prompts, corresponding responses, and tables used to determine the responses, for example from a database that stores previous prompts that assistant system 110 has received, tables that were used to generate answers, and/or corresponding answers. For example, assistant system 110 can access a database that stores previous natural language prompts, corresponding responses that were generated in response to the prompts, queries in a programming language that were translated from the previous prompts, and/or tables that were used to determine the corresponding responses.

In some cases, assistant system 110 can determine usage of tables in a database based on the historical data. For example, assistant system 110 can evaluate the usage of tables in the database to determine, for each table, a frequency of the usage (e.g., how frequently a table was accessed/used to generate a response), a portion(s) or part(s) of a table that is used or not used, an update status, user feedback, any error in data, and so on.

In some implementations, assistant system 110 can reorganize the database based on the usage of the tables to reduce redundancy and improve efficiency. For example, assistant system 110 can restructure data (e.g., tables) in the database based on the evaluation of the usage of the tables. For example, assistant system 110 can organize and format the tables that are frequently accessed and used to make them easier to analyze (e.g., via reshaping data, converting data types, etc.). In another example, assistant system 110 can remove errors in the tables (e.g., deleting empty cells or rows, etc.) or reduce the columns or cells that have never been accessed or not used for a certain period of time.

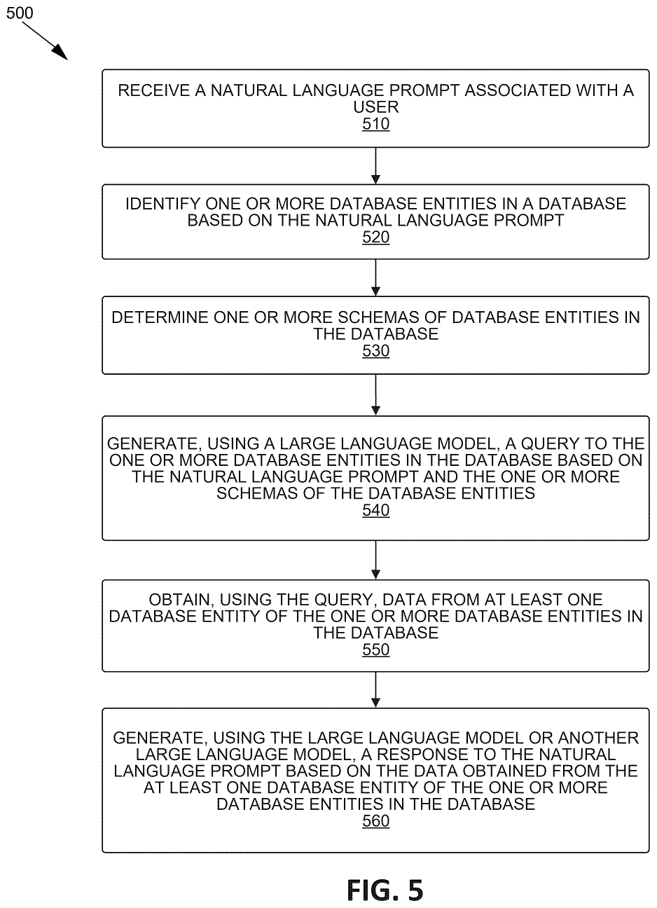

FIG. 5 is a diagram illustrating a flowchart of an example method 500 for using an AI model to facilitate natural language interactions with databases. The method 500 can be done by a server or back-end/cloud system, or by a client (or a client device). Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 1 and 2. However, method 500 is not limited to those examples.

In step 510, a client device implementing assistant system 110 can receive a natural language prompt associated with a user (e.g., a prompt from a user or a prompt from a device associated with the user). As previously described, assistant system 110 can receive user prompt 202, which can include a text input, a voice input, a gesture input, etc.

In step 520, a client device implementing assistant system 110 can identify one or more database entities. The database entities (or data structures) can include, for example and without limitation, tables, objects, classes of objects, documents, or key-value pairs. In some examples, a client device implementing assistant system 110 can determine the relevancy of database entities in a database to the user prompt based on various parameters such as, for example, content (e.g., words/utterances, syntaxes, etc.) of user prompt, confidence metrics of entities, descriptions of entities, similarities or dissimilarities between the user prompt and information associated with the entities, and so on.

In step 530, a client device implementing assistant system 110 can determine one or more schemas of database entities in the database. For example, a client device implementing assistant system 110 can determine schemas of entities that are identified as relevant in step 520. The schemas of database entities can include, for example and without limitation, a name, a description, a relationship to other entities, keys, metadata, data types of data in the entity, rules or constraints, etc.

In step 540, a client device implementing assistant system 110 can generate, using a large language model, a query to the database entities in the database based on the natural language prompt and the schemas of database entities in the database. For example, a client device implementing assistant system 110 can use an LLM to generate, based on schemas of the database entities and the user prompt, a query in a programming language. The LLM can translate the user prompt in a natural language and use the translation to generate a query.

In step 550, a client device implementing assistant system 110 can obtain, using the query, data from at least one database entity of the database entities in the database. For example, a client device implementing assistant system 110 can use the query (generated from step 540) to retrieve data from database entities in the database.

In step 560, a client device implementing assistant system 110 can generate, using the large language model or another large language model, a response to the natural language prompt based on the data obtained from the at least one database entity in the database. For example, an LLM can generate a response to the user prompt based on the data obtained from the database entity(es) in the database.

### Example Neural Network Architectures and Models

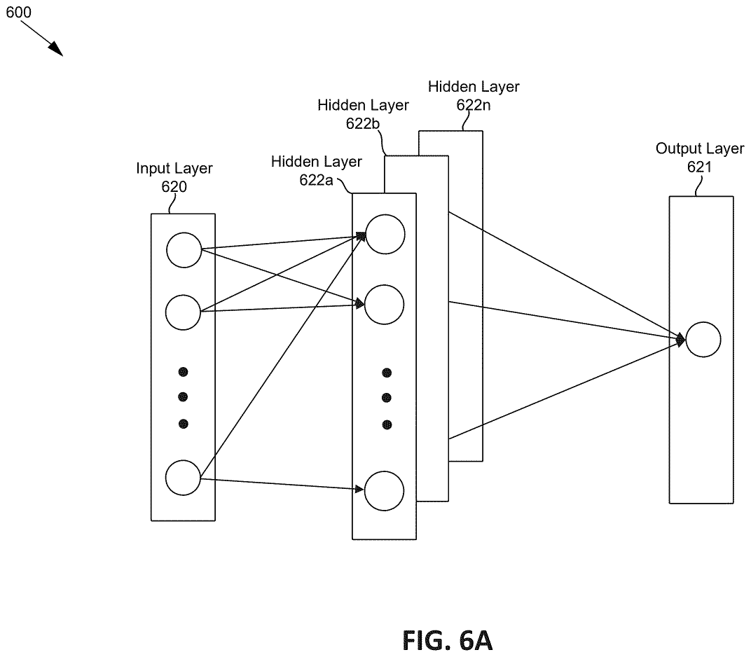

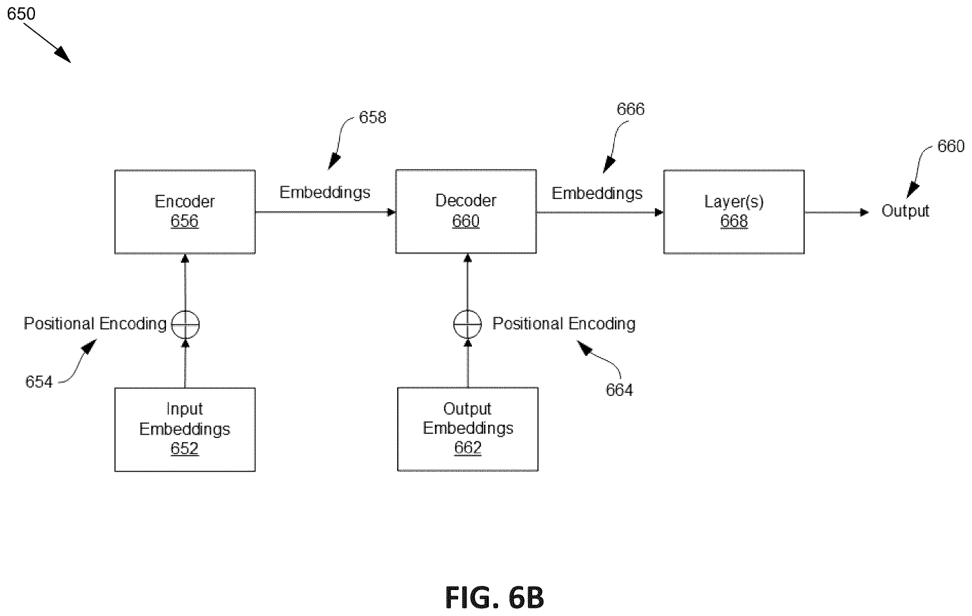

FIG. 6A is a diagram illustrating an example of a neural network architecture 600 that can be used to implement some or all of the neural networks described herein (e.g., LLM 112). The neural network architecture 600 can include an input layer 620 can be configured to receive and process data to generate one or more outputs. The neural network architecture 600 also includes hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. The neural network architecture 600 further includes an output layer 621 that provides an output resulting from the processing performed by the hidden layers 622a, 622b, through 622n.

The neural network architecture 600 is a multi-layer neural network of interconnected nodes. Each node can represent a piece of information. Information associated with the nodes is shared among the different layers and each layer retains information as information is processed. In some cases, the neural network architecture 600 can include a feed-forward network, in which case there are no feedback connections where outputs of the network are fed back into itself. In some cases, the neural network architecture 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 621, at which an output is provided. In some cases, while nodes in the neural network architecture 600 are shown as having multiple output lines, a node can have a single output and all lines shown as being output from a node represent the same output value.

In some cases, each node or interconnection between nodes can have a weight that is a set of parameters derived from the training of the neural network architecture 600. Once the neural network architecture 600 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network architecture 600 to be adaptive to inputs and able to learn as more and more data is processed.

The neural network architecture 600 is pre-trained to process the features from the data in the input layer 620 using the different hidden layers 622a, 622b, through 622n in order to provide the output through the output layer 621.

In some cases, the neural network architecture 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network architecture 600 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(1/2(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network architecture 600 can perform a backward pass by determining which inputs (weights) most contributed to the loss of the network, and can adjust the weights so that the loss decreases and is eventually minimized.

The neural network architecture 600 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network architecture 600 can include any other deep network other than a CNN, such as an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 6B is a diagram illustrating an example architecture of an example transformer model 650, according to some examples of the present disclosure. The transformer model 650 can be used to implement an LLM, such as LLM 112, LLM 212, LLM 230, and/or LLM 240. As shown, the transformer model 650 can include input embeddings 652 used as inputs to the transformer model 650. The input embeddings 652 can include input values representing words and/or sentences, such as numbers or vectors representing words and/or sentences.

In some cases, the input embeddings 652 can function like a dictionary that helps the transformer model 650 understand the meaning of words by placing them in an embedding space where similar words are located near each other. In some examples, the transformer model 650 can additionally or alternatively learn to create and/or process the input embeddings 652 during training.

The transformer model 650 can use positional encoding 654 to encode the position of each word in an input sequence from the input embeddings 652 as values such as a set of numbers, a vector, etc. The values generated by the positional encoding 654 can be fed into the transformer model 650 along with the input embeddings 652. By incorporating the positional encoding 654 into the transformer model 650, the transformer model 650 can more effectively understand the order of words in a sentence and generate grammatically correct and semantically meaningful output.

The transformer model 650 can include an encoder(s) 656 used to process the positionally encoded input embeddings 652 and generate embeddings 658. The encoder(s) 656 can be part of the transformer model 650 that processes input text and generates hidden states that capture the meaning and context of the text. For example, the encoder(s) 656 can include a feed-forward neural network that is part of the transformer model 650. In some examples, the encoder(s) 656 can implement multiple encoder layers. In some cases, the encoder(s) 656 can first tokenize the input text into a sequence of tokens, such as individual words or subwords. The encoder(s) 656 can then apply one or more self-attention layers, which can generate hidden states that represent the input text at different levels of abstraction. In this way, the encoder(s) 656 can generate the embeddings 658 (e.g., a vector, a set of values, etc.) representing the semantics and position of words in one or more sentences.

The transformer model 650 can include output embeddings 662, which can include values representing words and/or sentences, such as numbers or vectors representing words and/or sentences. The output embeddings 662 can be similar to the input embeddings 652 and can also be processed by positional encoding 664 to encode the position of each word in a sequence from the output embeddings 662 as values such as a set of numbers, a vector, etc., which helps the transformer model 650 understand the order of words in a sentence. The output embeddings 662 can be used during a training phase of the transformer model 650 and can be used during an inference phase. During training, a loss function can be computed based on the output embeddings 662 and used to update the model parameters to improve the accuracy of the transformer model 650. During an inference phase, the output embeddings 662 can be used to generate the output text by mapping the predicted probabilities determined by the transformer model 650 for each token to the corresponding token in the vocabulary.

The positionally encoded input embeddings 652 (e.g., the embeddings 658) and the positionally encoded output embeddings 662 can be fed to a decoder(s) 660 used to generate the output sequence based on the encoded input sequence. During training, the decoder(s) 660 can learn how to guess the next word of a sequence by looking at the words before it. In some examples, the decoder(s) 660 can generate natural language text based on the input sequence and any learned context.

The decoder(s) 660 can generate embeddings 666 and feed the embeddings 666 to one or more network layers 668. In some examples, the one or more network layers 668 can include a linear layer and a softmax function. The linear layer can map the embeddings 666 generated by the decoder(s) 660 to a higher-dimensional space, which can transform the embeddings 666 into the original input space. The softmax function can then be applied to generate a probability distribution for each output token in the vocabulary, which can result in an output 670. In some examples, the output 670 can include output tokens with probabilities.

### Example Computer System

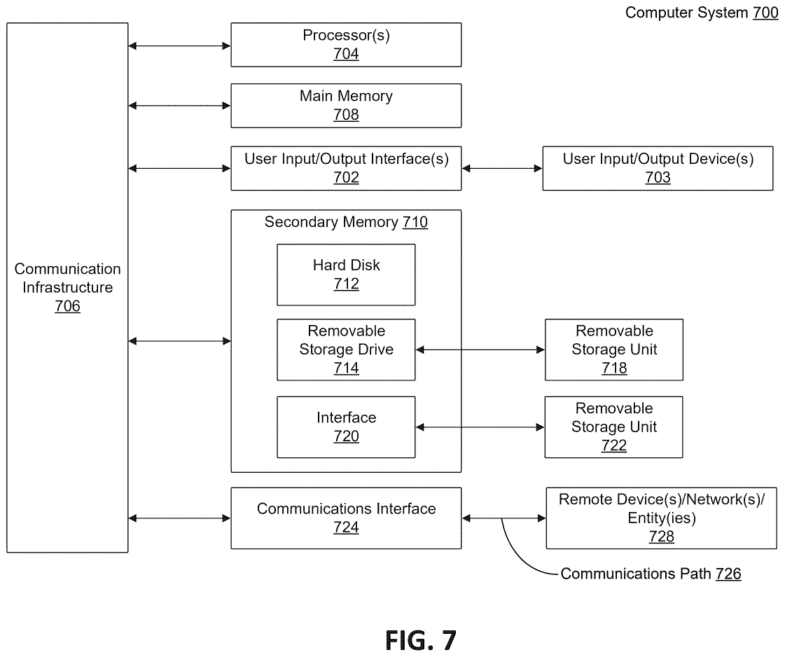

Various aspects and examples may be implemented, for example, using one or more well-known computer systems, such as computer system 700 shown in FIG. 7. For example, assistant system 110 may be implemented using combinations or sub-combinations of computer system 700. Also or alternatively, one or more computer systems 700 may be used, for example, to implement any of the aspects and examples discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (e.g., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 700 may include a communication or network interface 724. Communication interface 724 may enable computer system 700 to communicate and interact with any combination of external devices, external networks, external entities, etc. (individually and collectively referenced by reference number 728). For example, communication interface 724 may allow computer system xx00 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communications path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700 or processor(s) 704), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: memory; and one or more processors coupled to the memory and configured to perform operations comprising: receiving a natural language prompt associated with a user; identifying one or more tables in a database based on the natural language prompt; determining one or more table schemas of the one or more tables in the database; generating, using a large language model, a query to the one or more tables in the database based on the natural language prompt and the one or more table schemas; obtaining, using the query, data from at least one table of the one or more tables in the database; and generating, using the large language model or another large language model, a response to the natural language prompt based on the data obtained from the at least one table of the one or more tables in the database.

Aspect 2. The system of Aspect 1, wherein the one or more processors are configured to perform operations further comprising: generating, one or more statistics about the data from the at least one table of the one or more tables in the database.

Aspect 3. The system of any of Aspects 1 to 2, wherein the one or more processors are configured to perform operations further comprising: generating, using the large language model or an additional large language model, a description of one or more statistics about the data from the at least one table of the one or more tables in the database.

Aspect 4. The system of any of Aspects 1 to 3, wherein the one or more processors are configured to perform operations further comprising: generating, using the large language model or an additional large language model, a visualization of one or more statistics about the data from the at least one table of the one or more tables in the database.

Aspect 5. The system of any of Aspects 1 to 4, wherein identifying the one or more tables comprises: identifying a table in the database based on the natural language prompt; receiving user feedback with respect to the table or the response to the natural language prompt; and based on the user feedback, identifying the one or more tables, wherein the one or more tables comprise at least one of the table and a different table.

Aspect 6. The system of any of Aspects 1 to 5, wherein the one or more processors are configured to perform operations further comprising: determining an amount of at least one of computation resources and computation time used by the system to process the natural language prompt; and in response to determining that the amount of at least one of the computation resources and the computation time exceeds a threshold, modifying the natural language prompt prior to identifying the one or more tables in the database.

Aspect 7. The system of any of Aspects 1 to 6, wherein identifying the one or more tables comprises identifying the one or more tables based on one or more previous natural language prompts and one or more summaries of one or more responses determined for the one or more previous natural language prompts, the one or more previous natural language prompts comprising one or more natural language prompts received or processed by the large language model prior to the large language model receiving or processing the natural language prompt.

Aspect 8. The system of any of Aspects 1 to 7, wherein the one or more processors are configured to perform operations further comprising: determining a respective similarity between the natural language prompt and each previous natural language prompt from a plurality of previous natural language prompts received or processed by the large language model prior to the large language model receiving or processing the natural language prompt; and providing, to a device associated with the user, a previous natural language prompt from the plurality of previous natural language prompts and a previous response to the previous natural language prompt, the previous natural language prompt being selected from the plurality of previous natural language prompts based on the respective similarity between the natural language prompt each previous natural language prompt from the plurality of previous natural language prompts.

Aspect 9. The system of any of Aspects 1 to 8, wherein the one or more processors are configured to perform operations further comprising: identifying the one or more tables in the database based on a respective confidence metric of each of the one or more tables in the database.

Aspect 10. The system of any of Aspects 1 to 9, wherein the one or more processors are configured to perform operations further comprising: generating, using the large language model, a plurality of responses to the natural language prompt, wherein each response from the plurality of responses is generated based on data obtained from a respective table in the database; and identifying one or more differences between the plurality of responses that are generated from different tables.

Aspect 11. A method comprising: receiving a natural language prompt associated with a user; identifying one or more tables in a database based on the natural language prompt; determining one or more table schemas of the one or more tables in the database; generating, using a large language model, a query to the one or more tables in the database based on the natural language prompt and the one or more table schemas; obtaining, using the query, data from at least one table of the one or more tables in the database; and generating, using the large language model or another large language model, a response to the natural language prompt based on the data obtained from the at least one table of the one or more tables in the database.

Aspect 12. The method of Aspect 11, further comprising: generating, one or more statistics about the data from the at least one table of the one or more tables in the database.

Aspect 13. The method of any of Aspects 11 to 12, further comprising: generating, using the large language model or an additional large language model, a description of one or more statistics about the data from the at least one table of the one or more tables in the database.

Aspect 14. The method of any of Aspects 11 to 13, further comprising: generating, using the large language model or an additional large language model, a visualization of one or more statistics about the data from the at least one table of the one or more tables in the database.

Aspect 15. The method of any of Aspects 11 to 14, wherein identifying the one or more tables comprises: identifying a table in the database based on the natural language prompt; receiving user feedback with respect to the table or the response to the natural language prompt; and based on the user feedback, identifying the one or more tables, wherein the one or more tables comprise at least one of the table and a different table.

Aspect 16. The method of any of Aspects 11 to 15, further comprising: determining an amount of at least one of computation resources and computation time used by a system to process the natural language prompt; and in response to determining that the amount of at least one of the computation resources and the computation time exceeds a threshold, modifying the natural language prompt prior to identifying the one or more tables in the database.

Aspect 17. The method of any of Aspects 11 to 16, wherein identifying the one or more tables comprises identifying the one or more tables based on one or more previous natural language prompts and one or more summaries of one or more responses determined for the one or more previous natural language prompts, the one or more previous natural language prompts comprising one or more natural language prompts received or processed by the large language model prior to the large language model receiving or processing the natural language prompt.

Aspect 18. The method of any of Aspects 11 to 17, further comprising: determining a respective similarity between the natural language prompt and each previous natural language prompt from a plurality of previous natural language prompts received or processed by the large language model prior to the large language model receiving or processing the natural language prompt; and providing, to a device associated with the user, a previous natural language prompt from the plurality of previous natural language prompts and a previous response to the previous natural language prompt, the previous natural language prompt being selected from the plurality of previous natural language prompts based on the respective similarity between the natural language prompt each previous natural language prompt from the plurality of previous natural language prompts.

Aspect 19. The method of any of Aspects 11 to 18, further comprising: identifying the one or more tables in the database based on a respective confidence metric of each of the one or more tables in the database.

Aspect 20. A non-transitory computer-readable medium having instructions stored thereon that, when executed by at least one computing device, cause the at least one computing device to perform a method according to any of Aspects 11 to 19.

Aspect 21. A system comprising means for performing a method according to any of Aspects 11 to 19.

Aspect 22. A computer program product having stored thereon instructions which, when executed by one or more processors, cause the one or more processors to perform a method according to any of Aspects 11 to 19.

What is claimed is:

1. A system comprising:
memory; and
one or more processors coupled to the memory and configured to perform operations comprising:
receiving a natural language prompt associated with a user;
identifying one or more tables in a database based on the natural language prompt;
determining one or more table schemas of the one or more tables in the database;
generating, using a large language model, a query to the one or more tables in the database based on the natural language prompt and the one or more table schemas;
obtaining, using the query, data from at least one table of the one or more tables in the database; and
generating, using the large language model or another large language model, a response to the natural language prompt based on the data obtained from the at least one table of the one or more tables in the database.

2. The system of claim 1, wherein the one or more processors are configured to perform operations further comprising:
generating, one or more statistics about the data from the at least one table of the one or more tables in the database.

3. The system of claim 1, wherein the one or more processors are configured to perform operations further comprising:
generating, using the large language model or an additional large language model, a description of one or more statistics about the data from the at least one table of the one or more tables in the database.

4. The system of claim 1, wherein the one or more processors are configured to perform operations further comprising:
generating, using the large language model or an additional large language model, a visualization of one or more statistics about the data from the at least one table of the one or more tables in the database.

5. The system of claim 1, wherein identifying the one or more tables comprises:
identifying a table in the database based on the natural language prompt;
receiving user feedback with respect to the table or the response to the natural language prompt; and
based on the user feedback, identifying the one or more tables, wherein the one or more tables comprise at least one of the table and a different table.

6. The system of claim 1, wherein the one or more processors are configured to perform operations further comprising:
determining an amount of at least one of computation resources and computation time used by the system to process the natural language prompt; and
in response to determining that the amount of at least one of the computation resources and the computation time exceeds a threshold, modifying the natural language prompt prior to identifying the one or more tables in the database.

7. The system of claim 1, wherein identifying the one or more tables comprises identifying the one or more tables based on one or more previous natural language prompts and one or more summaries of one or more responses determined for the one or more previous natural language prompts, the one or more previous natural language prompts comprising one or more natural language prompts received or processed by the large language model prior to the large language model receiving or processing the natural language prompt.

8. The system of claim 1, wherein the one or more processors are configured to perform operations further comprising:
determining a respective similarity between the natural language prompt and each previous natural language prompt from a plurality of previous natural language prompts received or processed by the large language model prior to the large language model receiving or processing the natural language prompt; and
providing, to a device associated with the user, a previous natural language prompt from the plurality of previous natural language prompts and a previous response to the previous natural language prompt, the previous natural language prompt being selected from the plurality of previous natural language prompts based on the respective similarity between the natural language prompt each previous natural language prompt from the plurality of previous natural language prompts.

9. The system of claim 1, wherein the one or more processors are configured to perform operations further comprising:
identifying the one or more tables in the database based on a respective confidence metric of each of the one or more tables in the database.

10. The system of claim 1, wherein the one or more processors are configured to perform operations further comprising:
generating, using the large language model, a plurality of responses to the natural language prompt, wherein each response from the plurality of responses is generated based on data obtained from a respective table in the database; and
identifying one or more differences between the plurality of responses that are generated from different tables.

11. A method comprising:
receiving a natural language prompt associated with a user;
identifying one or more tables in a database based on the natural language prompt;
determining one or more table schemas of the one or more tables in the database;
generating, using a large language model, a query to the one or more tables in the database based on the natural language prompt and the one or more table schemas;
obtaining, using the query, data from at least one table of the one or more tables in the database; and
generating, using the large language model or another large language model, a response to the natural language prompt based on the data obtained from the at least one table of the one or more tables in the database.

12. The method of claim 11, further comprising:
generating, one or more statistics about the data from the at least one table of the one or more tables in the database.

13. The method of claim 11, further comprising:
generating, using the large language model or an additional large language model, a description of one or more statistics about the data from the at least one table of the one or more tables in the database.

14. The method of claim 11, further comprising:
generating, using the large language model or an additional large language model, a visualization of one or more statistics about the data from the at least one table of the one or more tables in the database.

15. The method of claim 11, wherein identifying the one or more tables comprises:
identifying a table in the database based on the natural language prompt;
receiving user feedback with respect to the table or the response to the natural language prompt; and
based on the user feedback, identifying the one or more tables, wherein the one or more tables comprise at least one of the table and a different table.

16. The method of claim 11, further comprising:
determining an amount of at least one of computation resources and computation time used by a system to process the natural language prompt; and
in response to determining that the amount of at least one of the computation resources and the computation time exceeds a threshold, modifying the natural language prompt prior to identifying the one or more tables in the database.

17. The method of claim 11, wherein identifying the one or more tables comprises identifying the one or more tables based on one or more previous natural language prompts and one or more summaries of one or more responses determined for the one or more previous natural language prompts, the one or more previous natural language prompts comprising one or more natural language prompts received or processed by the large language model prior to the large language model receiving or processing the natural language prompt.

18. The method of claim 11, further comprising:
determining a respective similarity between the natural language prompt and each previous natural language prompt from a plurality of previous natural language prompts received or processed by the large language model prior to the large language model receiving or processing the natural language prompt; and
providing, to a device associated with the user, a previous natural language prompt from the plurality of previous natural language prompts and a previous response to the previous natural language prompt, the previous natural language prompt being selected from the plurality of previous natural language prompts based on the respective similarity between the natural language prompt each previous natural language prompt from the plurality of previous natural language prompts.

19. The method of claim 11, further comprising:
identifying the one or more tables in the database based on a respective confidence metric of each of the one or more tables in the database.

20. A non-transitory computer-readable medium having instructions stored thereon that, when executed by one or more processors, cause the one or more processors to perform operations comprising:
receiving a natural language prompt associated with a user;
identifying one or more tables in a database based on the natural language prompt and a respective confidence metric of each of the one or more tables in the database;
determining one or more table schemas of the one or more tables in the database; and
generating, using a large language model, a summary of a response to the natural language prompt based on at least one of data from the one or more tables used to determine the response to the natural language prompt, the one or more table schemas of the one or more tables, and a description of one or more statistics about the data from the one or more tables used to determine the response.
